(19) United States
(12) Patent Application Publication
(10) Pub. No.: US 2013/0233837 A1
(43) Pub. Date: Sep. 12, 2013

(54) NOZZLE ASSEMBLY FOR LASER CUTTING APPARATUS

(71) Applicants: SHENZHEN FUTAIHONG PRECISION INDUSTRY CO., LTD., Shenzhen (CN); FIH (HONG KONG) LIMITED, Kowloon (HK)

(72) Inventor: MING-MING CHEN, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/690,253

(22) Filed: Nov. 30, 2012

(30) Foreign Application Priority Data
Mar. 9, 2012 (CN) 201210060850.1

(51) Int. Cl. B23K 26/38

(52) U.S. Cl. CPC B23K 26/38
USPC 219/121.67

(57) ABSTRACT

A laser cutting apparatus includes a galvo scanner system and a nozzle assembly. The galvo scanner system includes an outlet. The nozzle assembly includes a nozzle and a sleeve threadedly connected to each other, the sleeve mounted on the outlet of the galvo scanner system, the nozzle defining an air entrance. A gas supply is connected to the air entrance, and flows out of the nozzle.

### BACKGROUND

1. Technical Field

The exemplary disclosure generally relates to laser cutting apparatus, and particularly to a nozzle assembly for laser cutting apparatus.

2. Description of Related Art

Laser cutting apparatuses usually project a laser beam onto a surface of a workpiece to gasify the removed material for forming a predetermined pattern. However, to gasify the removed material, the laser beam needs to have a high energy. The high energy laser beam might deform or damage the workpiece.

Therefore, there is room for improvement within the art.

### BRIEF DESCRIPTION OF THE DRAWINGS

Many aspects of the nozzle assembly for laser cutting apparatus can be better understood with reference to the following drawings. The components in the drawings are not necessarily drawn to scale, the emphasis instead being placed upon clearly illustrating the principles of the nozzle assembly for laser cutting apparatus, in which:

FIG. 1 is an exploded, isometric view of a portion of laser cutting apparatus including a galvo scanning system and a nozzle assembly, in accordance with an exemplary embodiment.

FIG. 2 is an assembled view of the portion of laser cutting apparatus shown in FIG. 1.

FIG. 3 is a cross-sectional view of the nozzle assembly shown in FIG. 2.

### DETAILED DESCRIPTION

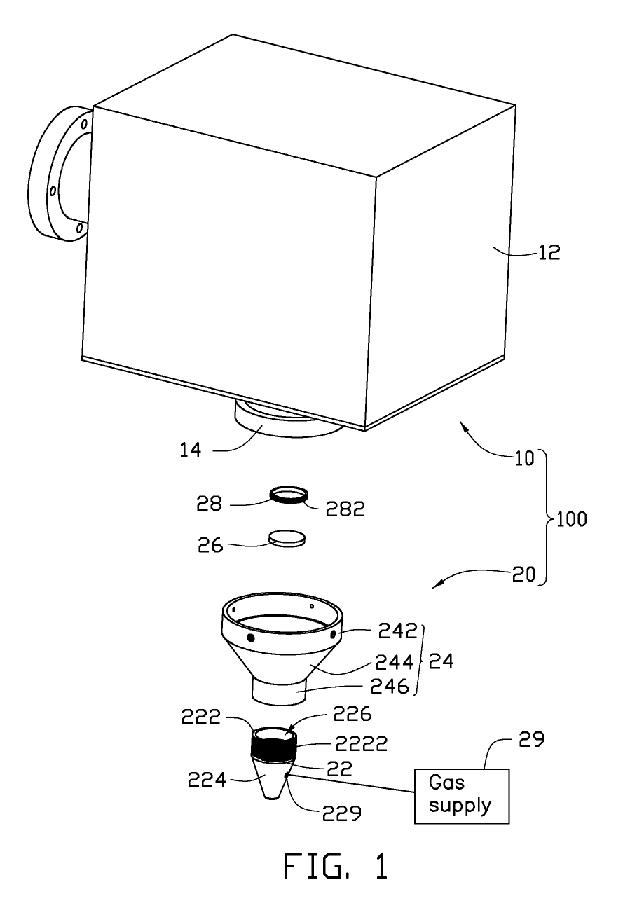

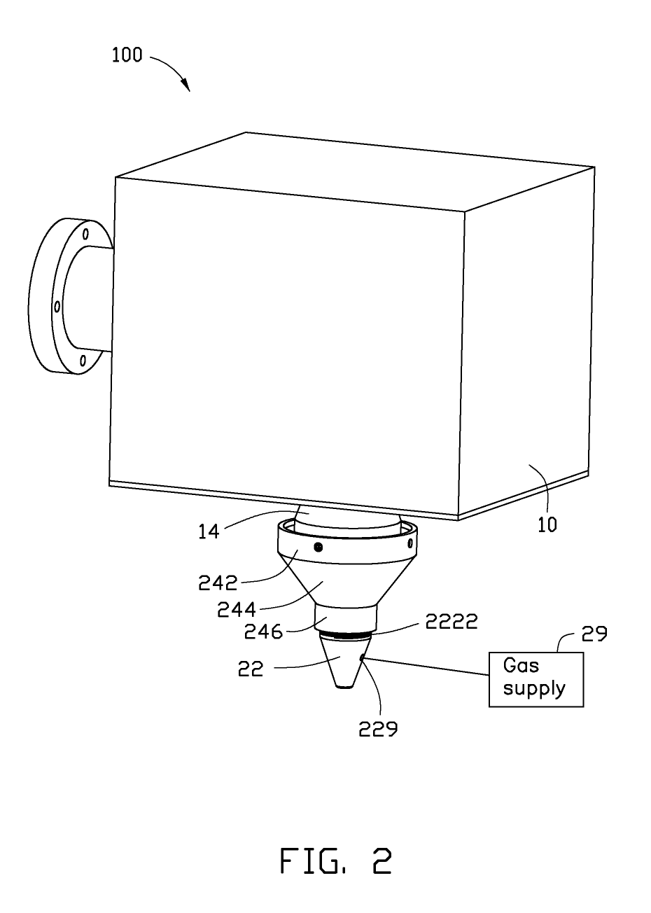

FIGS. 1 and 2 show an exemplary embodiment of a portion of a laser cutting apparatus 100 including a galvo scanning system 10 and a nozzle assembly 20.

The galvo scanning system 10 includes a main body 12 and an outlet 14. A plurality of optical elements (not shown) are positioned in the main body 12. The laser beam of the laser cutting apparatus 100 can pass through the galvo scanning system 10 and is radiated out of the outlet 14.

The nozzle assembly 20 includes a nozzle 22, a sleeve 24, a lens 26 and a latching ring 28.

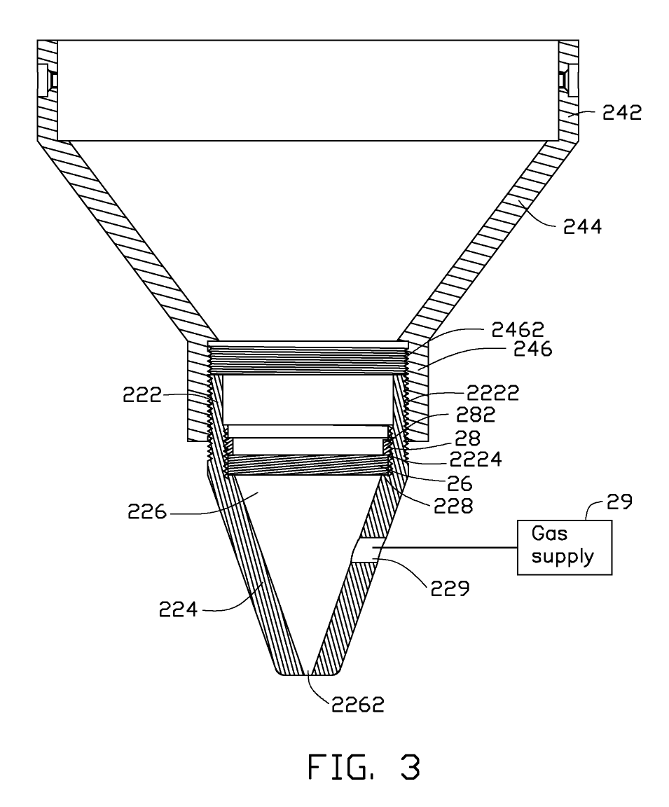

Referring to FIG. 3, the nozzle 22 includes a cylindrical portion 222 and a conical portion 224 that are integrally formed together. A step 228 is formed between the cylindrical portion 222 and the conical portion 224. A through hole 226 is defined in the cylindrical portion 222 and the conical portion 224. The conical portion 224 defines a mouth 2262. The laser beam from the outlet 14 can pass through the through hole 226 and the mouth 2262 and is radiated on a surface of a workpiece. The conical portion 224 defines an entrance 229. A gas supply 29 is connected to the entrance 229. The gas supply 29 provides a high pressure gas. The high pressure gas is fed into the conical portion 224 from the entrance 229. A first outer thread 2222 is formed on an outside periphery of the cylindrical portion 222, and a first inner thread 2224 is formed on an inside periphery of the cylindrical portion 222.

The sleeve 24 includes a first mounting portion 242, a connecting portion 244, and a second mounting portion 246. The first mounting portion 242 is used for connecting the outlet 14 of the galvo scanner system 10, and the second mounting portion 246 is used for connecting the nozzle 22. The second mounting portion 246 defines a second inner thread 2462. The connecting portion 244 is configured for guiding the laser beam.

The lens 26 is mounted in the through hole 226, and one side of the lens 26 abuts against the step 228. The latching ring 28 defines a second outer thread 282. The second outer thread 282 of the latching ring 28 is engaged with the first inner thread 2224, of the cylindrical portion 222, and abuts against the lens 26.

In assembly, the lens 26 is received into the through hole 226, and one side of the lens 26 abuts against the step 228. The second outer thread 282 of the latching ring 28 is threadedly engaged with the first inner thread 2224 and is forced on the lens 26. The latching ring 28 can prevent the lens 26 from loosening. Then, the nozzle 22 is connected to the second mounting portion 246 of the sleeve 24. The first mounting portion 242 of the sleeve 24 is connected to the outlet 14 of the galvo scanner system 10. Thus, the portion of the laser cutting apparatus 100 is finished.

In use, the laser beam of the laser cutting apparatus 100 passes through the galvo scanner system 10 to enter the sleeve 24 from the outlet 14. The connecting portion 244 of the sleeve 24 guides the laser beam to the nozzle 22. The laser beam from the mouth 2262 of the nozzle 22 is radiated on the workpiece for melting the predetermined portion of the workpiece. The high pressure gas of the gas supply 29 enters the nozzle 22 from the entrance 229 to blow away the molten material to ensure that the molten material is removed from the cut before it resolidifies. The present laser cutting apparatus does not need to gasify the material, and only needs to melt the material. Thus, the present laser cutting apparatus does not require as high level of energy relative to the conventional laser cutting apparatus.

It is to be understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A laser cutting apparatus comprising:
a galvo scanner system comprising an outlet;
a nozzle assembly comprising a nozzle and a sleeve threadedly connected to each other, wherein the sleeve is mounted on the outlet of the galvo scanner system, the nozzle defines an air entrance;
a gas supply connected to the air entrance, and flowing out of the nozzle.

2. The laser cutting apparatus as claimed in claim 1, further comprising a lens and a latching ring, wherein the lens is mounted in the nozzle, and the latching ring is threadedly engaged with the nozzle and abuts against the lens.

3. The laser cutting apparatus as claimed in claim 2, wherein the nozzle comprises a cylindrical portion and a conical portion integrally formed together, a step is formed between the cylindrical portion and the conical portion, and the lens abuts the step, and the conical portion defines the air entrance.

4. The laser cutting apparatus as claimed in claim 3, wherein a first outer thread is formed on an outside periphery of the cylindrical portion, and a first inner thread is formed on an inside periphery of the cylindrical portion, the sleeve defines a second inner thread threadedly connected to the first outer thread, and the latching ring defines a second outer thread threadedly connected to the first inner thread.

5. The laser cutting apparatus as claimed in claim 1, wherein the sleeve comprises a first mounting portion, a connecting portion, and a second mounting portion; the first mounting portion is connected the outlet of the galvo scanner system; and the second mounting portion is connected the nozzle.
